(19) United States
(12) Patent Application Publication
(10) Pub. No.: US 2025/0321808 A1
(43) Pub. Date: Oct. 16, 2025

(54) AUGMENTED LARGE LANGUAGE MODEL SYSTEM AND METHOD FOR COMMUNICATION WORKFLOWS

(71) Applicant: Grammarly, Inc., San Francisco, CA (US)

(72) Inventors: Dhruv Kumar, Vancouver (CA); Vipul Raheja, San Francisco, CA (US)

(21) Appl. No.: 18/634,637

(22) Filed: Apr. 12, 2024

(51) Int. Cl. G06F 9/54

(52) U.S. Cl. CPC G06F 9/54

(57) ABSTRACT

A method for performing computer-based tasks using computer applications and a machine learning model (MLM) includes identifying, within input data, a set of requests for performing corresponding computer-based tasks, utilizing the MLM. This identification process includes determining a computer application for executing the request and determining a programming instruction. The programming instruction includes a call to the computer application using an application programming interface (API) associated with the computer application. For the set of requests, the method includes generating computer instructions outlining a sequence for executing a set of programming instructions. Each instruction corresponds to the determined programming instruction and is configured with the associated API to accept input parameters generated from identified information within the input data, output parameters from the execution of any of the set of programming instructions, or a combination thereof. Finally, the method involves processing the computer instructions, leading to the generation of output data.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. @ 2023-2024 Grammarly, Inc.

### TECHNICAL FIELD

This disclosure relates to the application of data processing, particularly to natural language processing-based systems and methods for generating computer instructions for task processing.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Natural Language Processing (NLP) faces challenges related to its typical lack of direct access to real-time applications, which results in several drawbacks. Primarily, NLP systems often rely on previously learned data and lack real-time access. Consequently, these systems may base their decisions on outdated or incomplete information, leading to suboptimal outcomes, particularly when timely decisions are crucial. This limitation impacts the system's efficiency and reduces its ability to adapt to changing conditions and user needs.

Furthermore, the absence of real-time access to applications prevents NLP systems from automating tasks and processes as they occur, thereby affecting efficiency and productivity. Without this capability, opportunities for automation may be missed, resulting in manual intervention or inefficient workflows.

### SUMMARY

The appended claims may serve as a summary of the invention.

### BRIEF DESCRIPTION OF THE DRAWINGS

In the drawings:

FIG. 1 is a system for generating computer instructions and performing computer-based tasks in one embodiment.

FIG. 2 is a diagram illustrating an execution flow of programming instructions in one embodiment.

FIG. 3 illustrates a programmable method for generating computer instructions and

performing computer-based tasks in one embodiment.

FIG. 4 illustrates programmable methods for generating computer instructions in one embodiment.

FIG. 5A, FIG. 5B, FIG. 5C are diagrams illustrating a method for generating training data for training a machine-learning system for generating computer instructions in one embodiment.

FIG. 6 is an illustrative computer system suitable for implementing the methods described herein in one embodiment.

### DETAILED DESCRIPTION

### 1. General Overview

The embodiments disclosed herein are only examples, and the scope of this disclosure is not limited to them. Some embodiments may include all, some, or none of the components, elements, features, functions, operations, or steps of the embodiments disclosed herein. The attached claims to a method, a storage medium, and a system may recite a feature in one claim category within the scope of embodiments that could be claimed in another. The dependencies or back references in the attached claims are chosen for formal reasons only. However, any subject matter resulting from a deliberate reference to any previous claims (in particular multiple dependencies) can be claimed so that any combination of claims and the features thereof are disclosed and can be claimed regardless of the dependencies chosen in the attached claims. The subject matter that can be claimed comprises not only the combinations of features as set out in the attached claims but also any other combination of features in the claims, wherein each feature mentioned in the claims can be combined with any other feature or combination of other features. Furthermore, any embodiments and features described or depicted herein can be claimed in a separate claim and/or in any combination with any embodiment or feature described or depicted herein or with any of the features of the attached claims.

In the following description, numerous details are set forth to provide a thorough understanding of the present disclosure. It will be apparent, however, that embodiments of the present disclosure may be practiced without these specific details. In other instances, well-known structures and devices are shown in block diagram form to avoid unnecessarily obscuring the description of the present disclosure.

The text of this disclosure, in combination with the drawing figures, is intended to state in prose the algorithms that are necessary to program the computer to implement various embodiments at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement embodiments of the present disclosure.

Various embodiments may be described in this disclosure to illustrate various aspects. Other embodiments may be utilized, and structural, logical, software, electrical, and other changes may be made without departing from the scope of the embodiments that are specifically described. Various modifications and alterations are possible and expected. Some features may be described with reference to one or more embodiments or drawing figures, but such features are not limited to usage in the one or more embodiments or figures with reference to which they are described. Thus, the present disclosure is neither a literal description of all embodiments nor a listing of features that must be present in all embodiments.

Headings of sections and the title are provided for convenience but are not intended to limit the disclosure in any way or as a basis for interpreting the claims. Devices that are described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate various possible embodiments and to fully illustrate one or more aspects of the present disclosure. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary, and does not imply that the illustrated process is preferred. The steps may be described once per embodiment but need not occur only once. Some steps may be omitted in some embodiments or occurrences, or some steps may be executed more than once in each embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments need not include the device itself. Techniques and mechanisms described or referenced herein will sometimes be described in singular form for clarity. However, it should be noted that embodiments include multiple iterations of a technique or multiple manifestations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present disclosure in which, for example, functions may be executed out of order from that shown or discussed, including substantially concurrently or in reverse order, depending on the functionality involved.

The disclosed methods offer practical applications and technical advantages by leveraging one or more machine learning models (MLMs) to generate computer instructions based on user-provided descriptions. These instructions are then utilized for various tasks, including executing computer applications such as data processing, email transmission, and text processing, among others. The computer instructions may be human-readable text, including code instructions for various computer applications. This approach significantly enhances the efficiency of computing resources. For instance, without the approach of this disclosure, a user might need to perform various operations outlined in the computer instructions, such as opening emails, setting up meeting requests, processing data, or preparing code for executing at least some of the instructions. This approach becomes inefficient and time-consuming.

The disclosure addresses these issues by employing an MLM to generate computer instructions, including script commands or code, such as Python code describing calls to various software applications utilizing application programming interfaces (APIs) for performing various computer tasks. These generated computer instructions allow translating at least some user requests into executable code. This code can be applied in any suitable order, providing a more reliable and resource-efficient approach to performing computer tasks.

The disclosure also introduces an approach that streamlines user interaction and computer applications by enabling natural language input for computer instruction generation. An interface for inputting various requests to computer applications enhances accessibility for individuals without extensive programming expertise. An example interface may be a text interface for inputting text describing one or more requests represented by natural language sentences.

Moreover, the generated computer instructions, rooted in natural language descriptions, offer a level of interpretability. Users can comprehend the logic and intent behind the generated code. Additionally, the generated computer instructions may integrate with existing computer task workflows. Users can incorporate these functions into their current systems, enhancing overall efficiency without necessitating a complete overhaul.

Furthermore, users can dynamically adjust and modify processing rules using the methods described herein by updating the natural language descriptions. This dynamic flexibility enables quick adaptation to changing requirements or evolving patterns in the text data. Additionally, the generated computer instructions can be stored in a database, allowing for reuse in different computer tasks and facilitating collaboration between technical and non-technical users.

In an embodiment, the approach aligns with practical needs by combining the capabilities of machine-learning language models with user-friendly, adaptable, and resource-efficient solutions for computer task execution.

The disclosure encompasses the subject matter of the following numbered clauses:

1. A computer-implemented method comprising: using a machine learning model having a natural language processing capability, identifying, within input data, a task-specific computer application for performing a request for performing a computer-based task, and determining a request-related programming instruction, the request-related programming instruction comprising a call to the task-specific computer application using an application programming interface (API) associated with the task-specific computer application; repeating the identifying with the input data to yield a set of requests for performing a corresponding set of computer-based tasks; for the set of requests, generating computer instructions outlining a sequence for executing a set of request-related programming instructions, each one corresponding to the determined request-related programming instruction and having the associated API configured to accept as an input either one or more input parameters generated from identified information within the input data to be used for that API, one or more output parameters from an execution of any of the set of request-related programming instructions, or combination thereof; processing the computer instructions, causing generating of output data.

2. The computer-implemented method of clause 1, wherein the processing of the computer instruction further causes executing the set of request-related programming instructions, thereby performing the set of computer-based tasks.

3. The computer-implemented method of clause 1, further comprising:
providing, to the machine learning model, a list of task-specific applications available for performing computer-based tasks; analyzing the input data using natural language processing of the machine learning model to identify a set of task-specific applications from the list of task-specific applications for performing the corresponding set of computer-based tasks.

4. The computer-implemented method of clause 3, further comprising, for a request in the set of requests: identifying that the task-specific computer application is not part of the list of the task-specific computer applications; generating a message being a part of the output data indicating that the request cannot be performed.

5. The computer-implemented method of clause 1, wherein the computer-based tasks include one of: scheduling a meeting in a calendar based on one or more time slots identified within the input data, searching for information within a local database based on a search query identified with the input data, searching for information within external information sources based on the search query identified within the input data, uploading data to a local database, based on a set of instructions identified within the input data, processing one or more data records in accordance with the set of instructions, storing processed data records in a storage specified within the input data, moving one or more data records from one database to another database based on the set of instructions, or a combination thereof.

6. The computer-implemented method of clause 5, wherein the search query includes specific terms associated with data stored in the local database, and wherein determining whether to search the local database or the external information sources is determined based on a presence of the specific terms.

7. The computer-implemented method of clause 1, wherein the computer instructions include code-mixed text data; further comprising analyzing the computer instructions using a natural language processing model.

8. The computer-implemented method of Clause 1 wherein the set of request-related programming instructions includes at least a first request-related programming instruction and a second request-related programming instruction, the first request-related programming instruction being configured to generate at least one or more output parameters, and the second request-related programming instruction configured to take as input at least one or more input parameters; wherein processing the computer instructions comprises executing the first request-related programming instruction, before executing the second request-related programming instruction, thereby generating the one or more output parameters, and using at least one of the one or more output parameters as one of the one or more input parameters of the second request-related programming instruction.

9. The computer-implemented method of Clause 8, wherein executing the second request-related programming instruction is not performed based on a value of the at least one of the one or more output parameters of the first request-related programming instruction.

10. The computer-implemented method of Clause 1, wherein the computer instructions include one of a Python code, a Ruby code, a Perl Script, a JavaScript code, a Java code, a PHP code, a C code, or a C++ code.

11. The computer-implemented method of Clause 1, further comprising generating the computer instructions at least in part by determining based on output of one or more request-related programming instruction from the set of request-related programming instructions whether another request-related programming instruction form the set of request-related programming instructions should be performed.

12. The computer-implemented method of Clause 1, further comprising generating the output data by: executing processing instructions of computer instructions, thereby generating intermediate output data; processing the intermediate output data using a natural language processing model to generate the output data.

13. The computer-implemented method of Clause 1, further comprising training the machine learning model by: generating computer instructions by the machine learning model based on a training input data; calculating a loss function related to a difference between the generated computer instructions and corresponding expected computer instructions; and updating parameters of the machine learning model to reduce the loss function.

14. The computer-implemented method of Clause 13, wherein the training input data is generated using a generating model, the generating model is configured to take a plurality of training input data records for which the machine learning model is trained to generate the computer instructions having a required accuracy and combining several training input data records from the plurality of training input data records to generate the training input data.

15. The computer-implemented method of Clause 14, wherein the plurality of training input data records include one or more adjustable parameters, and wherein generating the training input data further comprises adjusting at least one of the one or more adjustable parameters prior to combining several input data records from the plurality of training input data records to generate the training input data.

16. The computer-implemented method of claim 15, wherein each one of the one or more adjustable parameters includes a list of possible values, any one of which can be selected for adjusting each one of the adjustable parameters.

17. The computer-implemented method of claim 1 wherein the input data is provided by a client device associated with a user, and wherein the input data is appended to include environmental variables associated with the client device, the environmental variables including access authentication for the client device and specific list of task-specific computer application available for the client device.

### 2. Example Distributed System and Processing Method

### 2.1 System Architecture

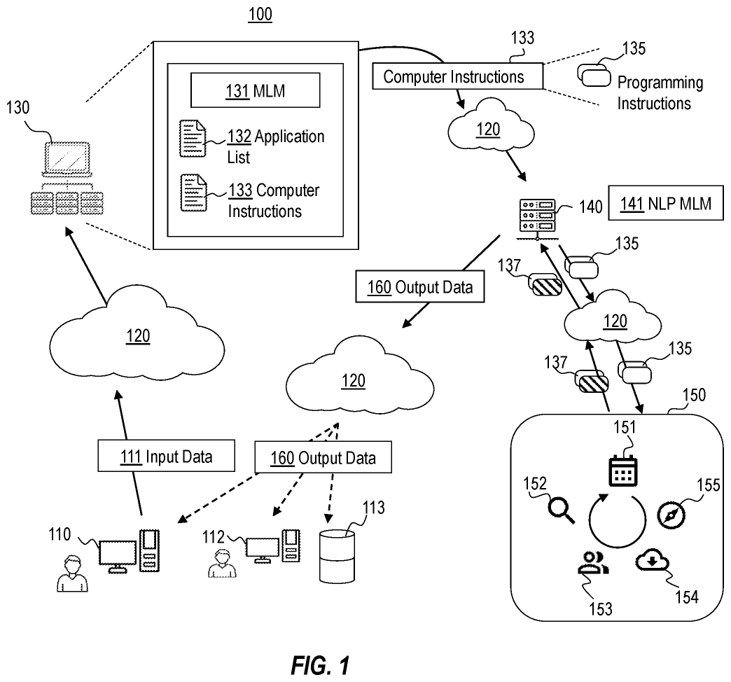

FIG. 1 is a system for generating computer instructions and performing computer-based tasks in one embodiment. In an embodiment, a computer system 100 comprises components implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of how to integrate NLP systems with real-time applications to overcome a lack of direct access to real-time applications. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

Various methods discussed herein can be performed by system 100, as shown in FIG. 1. System 100 includes a client device 110, a first computing system 130, a second computing system 140, and a network 120 configured to facilitate data exchange between the client device 110 and computing systems 130 and 140.

Client device 110 can be any suitable computing device capable of connecting to the first computing system 130 via network 120. For instance, client device 110 may include a laptop, desktop, smartphone, tablet, workstation, or any other electronic device operable by a user. Communication between client device 110 and first computing system 130 can be established through various means, such as a dedicated application, an internet browser, or any communication interface leveraging network communication protocols like Hypertext Transfer Protocol, WebSockets, and TCP/IP, among others. In various scenarios, client device 110 is configured to transmit input data 111 to first computing system 130 via network 120.

Network 120 includes the Internet, Intranet, local area network (LAN), wide-area network (WAN), Virtual Private Network (VPN), Wireless Local Area Network (WLAN), campus network, internetwork, or combinations thereof. It facilitates data exchange through LAN cards for compatible LANs, cellular radiotelephone interfaces for cellular data, or satellite radio interfaces for digital data based on satellite wireless networking standards. Regardless of the medium, network 120 is configured to transmit and receive digital data streams via electrical, electromagnetic, or optical signals.

First computing system 130 may include any suitable computing devices equipped with one or more processors for data processing and one or more memory devices for data storage. It could be represented by a distributed computing architecture, such as an edge computing system, a cloud computing system, or, in some instances, a virtual compute instance.

The memory devices of first computing system 130 include one or more non-transitory computer-readable storage media coupled to one or more processors. They are configured to store sequences of instructions for processing input data 111 received from client device 110. Subsequently, one or more processors of the first computing system, 130, perform the processing of input data 111.

In the illustrated embodiment in FIG. 1, client device 110 transmits input data 111 to the first computing system 130. The submission of input data 111 can be facilitated through an interface on client device 110, enabling users to input and review data. This interface may take various forms for entering text-based data. In some cases, the design and layout of such interfaces may be determined by first computing system 130, which, in turn, can present users with a webpage featuring form fields for inputting data 111. Additionally, first computing system 130 may interact with an application on the client device 110, updating the interface and exchanging data between the two.

Input data 111 in various embodiments may consist of text data requiring processing by first computing system 130. It may include text characters from any language, incorporating special characters, mathematical symbols, icons, bullets, and, occasionally, emojis or images. Furthermore, input data 111 may include attachments, which can be any suitable documents such as images, Word documents, PDF documents, audio files, video files, and the like.

Input data 111 can include requests to perform various computer tasks using computer applications with APIs for accessing such applications. Additionally, input data 111 may optionally include instructions describing how to utilize the various requests within input data 111 for executing computer tasks. These instructions, formulated in natural language or as scripts, may specify the sequence in which various requests are performed.

In an illustrative embodiment, a user provides input data 111 via a suitable user interface. This data is subsequently received and stored by first computing system 130 on one or more memory devices associated with it. As shown in FIG. 1, first computing system 130 is configured to include a machine learning model (MLM) 131, which includes related instructions stored on the memory devices associated with first computing system 130. MLM 131 is configured to convert input data 111 into computer instructions 133, which may be human-readable and contain both text data and computer code, represented by, for example, API calls to various software applications. This conversion process involves identifying within input data 111 one or more requests for performing corresponding one or more computer-based tasks. The one or more requests can be identified using MLM 131. When identifying a request within input data 111, MLM 131 is first configured to identify a task-specific computer application for performing the request.

In some cases, input data 111 may be appended to include environmental variables associated with client device 110. The environmental variables may include access authentication for client device 110 and a specific list of task-specific computer applications available for client device 110. Other environmental variables may include a time of the day input data 111 is provided to first computing system 130, a type of client device 110 that is used for providing input data 111, a type of software application used by client device 110 for interacting with first computing system 130, a location of client device 110, a number of times client device 110 contacted first computing system 130 in a past minute, hour, day, or any other suitable period of time, an account associated with a user that is using client device 110, or any other variables which may affect interaction between client device 110 and first computing system 130.

As shown in FIG. 1, the first computing system 130 may include an application list 132 describing various computer applications, such as computer applications 150, as shown in FIG. 1, which can be accessible for performing various computer tasks. In some cases, computer applications 150 may be stored in the memory of the first computing system 130 and may be executed by one or more processors of the first computing system 130. Alternatively, computer applications 150 may reside elsewhere (e.g., on a remote computing system or several remote computing systems) and may be accessible via network 120.

When task-specific computer applications are identified by MLM 131 by processing input data 111 (e.g., by using natural language processing of a text containing within input data 111), MLM 131 may further be configured to determine, for a particular request, a request-related programming instruction. The request-related programming instruction include a call to the task-specific computer application using an application programming interface (API) associated with the task-specific computer application. Such request-related programming instruction may be represented by a script or a code tailored to perform the designated computer task via a particular one of computer applications 150. For different requests identified by MLM 131 within input data 111, a set of request-related programming instructions 135 is formed (herein, also referred to as programming instructions 135).

When identified task-specific computer applications for performing requests are available as indicated by the application list 132, MLM 131 may be configured to proceed in generating computer instructions 133. Alternatively, when input data 111 includes a request for performing computer tasks by computer applications that are not available as indicated by application list 132, a message may be provided to a user of client device 110 to modify input data 111 due to the unavailability of at least some computer applications. For example, if input data 111 requests recognition of a particular object within attachments of input data 111, and there is no available computer application to perform such image recognition, a suitable message may be generated by MLM 131 of the first computing system 130 and provided to the user of client device 110.

Furthermore, MLM 131 is configured to generate computer instructions 133 outlining a sequence for executing programming instructions 135 previously determined for each request. Programming instructions 135 include API calls to various computer applications such as computer application 150 and input parameters for such API calls. Programming instructions 135 may be implemented in any suitable way and may include a Python code, a Ruby code, a Perl Script, a JavaScript code, a Java code, a PHP code, a C code, a C++ code, or any other suitable code written in any suitable computer language.

Generally, when utilizing API calls to access a specific computer application within the set of computer applications 150, such as computer application 151, the API call can be configured to receive input parameters for executing a computer task using that application. Alternatively, depending on the request, there may be cases where no input parameters are necessary for an API call. When input parameters are required, they can either be obtained (e.g., identified or, in some cases, generated) from input data 111. Alternatively, such input parameters may be selected to be at least some output results of the execution of another computer application within the set of computer applications 150.

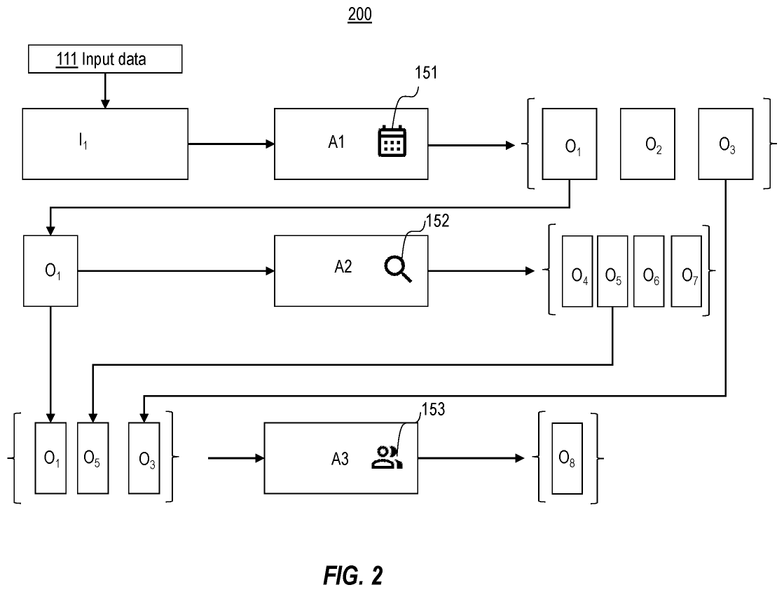

FIG. 2 is a diagram illustrating an execution flow of programming instructions in one embodiment. FIG. 2 and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

An example diagram 200 illustrates the flow of information expected during the execution of computing instructions containing three API calls—A1-A3. During the first API call (A1) related to computer application 151, input parameters I₁ may be identified from input data 111 or generated using input data 111. Subsequently, via the A1 call, output results O₁-O₃ are expected to be generated. Output result O₁ is then coded to be used as the input parameter for a second API call (A2) related to computer application 152. Computer application 152 is expected to generate output results O₄-O₇. Furthermore, output results O₁, O₅, and O₃ are coded to be used as input parameters for a third API call (A3) associated with computer application 153 to produce the output result O₈.

In one specific implementation, programming instructions 135 include at least a first request-related programming instruction and a second request-related programming instruction. The first request-related programming instruction is configured to generate one or more output parameters, while the second request-related programming instruction is configured to take one or more input parameters as input. Furthermore, during the processing of the computer instructions, the first request-related programming instruction is executed before executing the second request-related programming instruction, thus obtaining one or more output parameters. Additionally, at least one of the obtained output parameters is used as one of the input parameters for the second request-related programming instruction.

In some cases, executing the second request-related programming instruction may not be performed based on a value of at least one of the one or more output parameters of the first request-related programming instruction.

MLM 131 may be any suitable machine learning model. For example, MLM 131 may be a transformer model or may include several machine learning models (e.g., several transformer models), each configured to excel in a particular task. For example, MLM 131 may include several machine-learning models. A first MLM (MLM1) may be configured to identify request-related text strings within input data 111 corresponding to individual requests within input data 111, while a second MLM (MLM2) may be configured to identify for each request-related text string a task-specific computer application for performing a computer-based task. Further, a third MLM (MLM3) may excel in determining based on the request-related text strings and identified task-specific computer application request-related programming instructions. In an embodiment, when MLM 131 comprises multiple machine learning models, each one of the machine learning models may be trained separately, thereby streamlining the training of MLM 131. In some cases, MLM 131 may include additional MLMs that can be used for processing images (e.g., for image recognition and/or for processing audio or video data).

Returning to FIG. 1, after completing generating computer instructions 133, the first computing system 130 is configured to transmit computer instructions 133 to the second computing system 140. Second computing system 140 is configured to process computer instructions 133, generating output data.

The processing of computer instructions 133 includes extracting programming instructions 135 from the computer instructions and executing programming instructions 135 by invoking API calls to computer applications 150, thereby performing a set of computer-based tasks.

Computer applications 150 may include among others, a calendar application 151 for scheduling meetings, a search application 152 for searching information either within local databases, within remote databases, and/or within the Internet, email and chat application 153 for sending and receiving messages with various users, a cloud storage application 154 for storing and retrieving data in the cloud, map application 155, or any other suitable application (e.g., application for analyzing images, application for processing audio data, application for translating text, natural language processing MLMs for processing text, and the like). As shown in FIG. 1, programming instructions 135 invoke computer applications 150 via API calls, and as a result, output results 137 are returned from computer application 150 to the second computing system 140.

In some cases, computer applications 150 may perform computer-based tasks that include scheduling a meeting in a calendar based on one or more time slots identified within the input data 111, searching for information within a local database based on a search query identified with the input data 111, searching for information within external information sources based on the search query identified within the input data 111, uploading data to a local database, based on a set of instructions identified within the input data 111, processing one or more data records in accordance with a set of instructions identified within the input data 111, storing processed data records in storage specified within the input data 111, moving one or more data records from one database to another database based on a set of instructions identified within input data 111, or a combination thereof.

In various scenarios, the search query extracted from input data 111 may contain specific terms linked to data stored in the local database. The presence of these terms in the search query may suggest a need to explore the local database. For example, MLM 131 could be configured to scrutinize input data 111 for a predefined list of terms it recognizes. If this list includes terms like “Knowledge base” and “Orchestrator,” and input data 111 includes a search query such as “Please search Knowledge base for project ‘Orchestrator’,” MLM 131 can infer the necessity to search the local database. Additionally, MLM 131 might employ natural language processing to detect relevant cues within the search request. For instance, upon receiving a request like “Please search my email that contains Project Acme” or “Please search my email for information about internal combustion engines,” MLM 131 can determine the potential need for a local search. However, in cases where the search query lacks terms associated with local database data or fails to indicate a requirement for local database or data storage exploration, external information sources may be sought after.

Additionally, in certain scenarios, the second computing system 140 may analyze computer instructions 133 and generate a code containing programming instructions 135. Subsequently, the second computing system 140 can be configured to execute the generated code. For instance, it may execute the generated code in such a manner that programming instructions 135 are processed sequentially, and output results 137 generated by executed programming instructions 135 can serve as input parameters for at least some of the programming instructions 135 that have not yet been executed.

After receiving output results 137, second computing system 140 is configured to further process computer instructions, considering output results 137, to generate output data 160 and transmit output data 160 to either client device 110, another client device 112, or a storage system 113 which can be any suitable storage (e.g., database, distributed cloud-based storage, and the like). To obtain output data 160, second computing system 140 may use a suitable natural language processing (NLP) MLM 141 for analyzing computer instructions 133 and combine them with output results 137 to form output data 160. MLM 141 may be any suitable MLM for natural language processing and may include one or more transformer models and the like. In some cases, MLM 141 may invoke computer applications 150, which may include, among other things, various MLMs for performing particular computer tasks, including data processing and data analysis.

### 2.2 Data Processing Example

The example below demonstrates the possible operations of system 100. It should be noted that this example serves as an illustration, and numerous other data processing scenarios could be envisioned.

A user of a client device, such as client device 110, submits input data 111 like “Draft email to Max, find 45 minutes for us to meet next week, also, share with Max some background information on internal combustion engines by (1) analyzing documents in the Fueled Engines Folder on a work site and by (2) summarizing available state of the art information.” The input data 111 is processed by first computing system 130 to identify requests such as drafting an email to Max, finding 45 min for a meeting, presenting background information on IC engines based on documents in the work site in the specified folder, and presenting background information on IC engines based on an online search.

After the requests are identified, first computing system 130 is configured to generate computer instructions 133, which may include: “Draft email to Max; find 45 min for us to meet next week->Create_Meeting (“Max”, “45 minutes”, “next week”); also, share with Max some background information on internal combustion engines by (1) analyzing documents in a Fueled Engines folder on a work site and by (2) summarizing available state of the art information->Work Site_Search (“internal combustion engine”); Online_Search (“internal combustion engine”).” Computer instructions 133 include a first API call “Create_Meeting (‘Max’, ‘45 minutes’, ‘next week’).”

For the first API call, input parameters “Max,” “45 minutes,” and “next week” are determined by analyzing input data 111. The API call “Create_Meeting” is for a meeting scheduling application, such as computer application 151. Further, the command instructions include a second API call “Work_Site_Search (‘internal combustion engine’)” and a third API call “Online_Search (‘internal combustion engine’).” The second and third API calls may be for a search application 152 and may include input parameters determined by analyzing input data 111. Second computing system 140 is configured to execute API calls within computer instructions 133. Further, outputs from any of the API calls may be used for drafting emails to Max.

For example, if the output from Work_Site_Search (“ ”); Online_Search (“internal combustion engine”), is “Internal combustion engines typically comprise the combination of a fuel-fed motor and a transmission; motors often use pistons within cylinders, a fuel source that can be injected or fed into the pistons, and a source of an electric spark to ignite and cause the fuel to burn within the piston, so that the gaseous products of combustion force the piston to mechanically move,” such output is used for generating output data 160 which may include, for example, “Hello Max, I hope this message finds you well. I have set up a 45-minute meeting with you next Monday at 9 am PT to discuss internal combustion engines. Here is some background for the meeting: Internal combustion engines typically comprise the combination of a fuel-fed motor and a transmission; motors often use pistons within cylinders, a fuel source that can be injected or fed into the pistons, and a source of an electric spark to ignite and cause the fuel to burn within the piston, so that the gaseous products of combustion force the piston to mechanically move. Best regards.”

In some cases, before generating output data 160 an intermediate output data may be generated that might look as “Draft email to Max, find 45 mins for us to meet next week-> [Meeting scheduled with Max on Monday, 9:00 am PST for 45 minutes]. Also, share with Max some background information on internal combustion engines by (1) analyzing documents in a Fueled Engines Folder on a work site and by (2) summarizing available state-of-the-art information-> [Internal combustion engines typically comprise the combination of a fuel-fed motor and a transmission; motors often use pistons within cylinders, a fuel source that can be injected or fed into the pistons, and a source of an electric spark to ignite and cause the fuel to burn within the piston, so that the gaseous products of combustion force the piston to mechanically move.].” The intermediate output data may include at least some text data from input data 111 and new data obtained by executing API calls within input data 111. Subsequently, the intermediate output data may be processed by NLP MLM 141 associated with the second computing system 140 to generate output data 160.

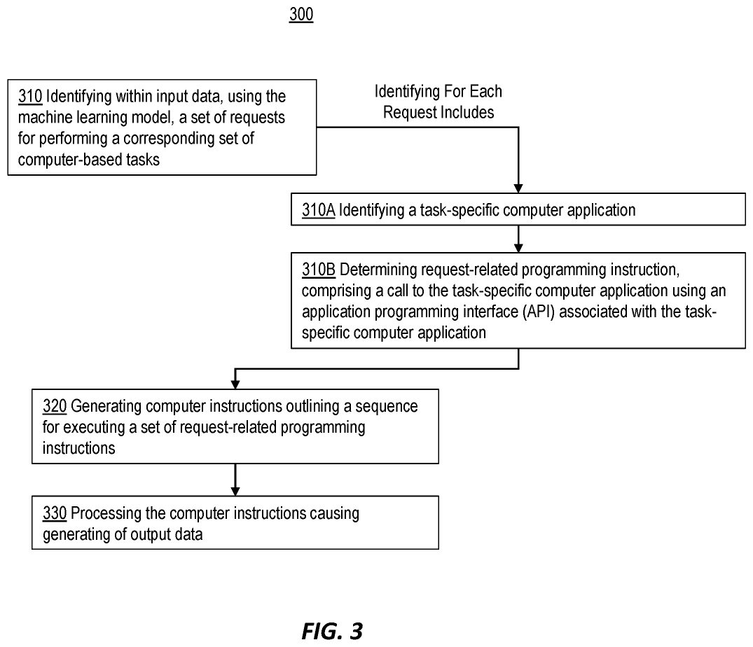

FIG. 3 is a method for generating computer instructions and performing computer-based tasks in one embodiment. FIG. 3 shows an illustrative method 300 of generating output data based on input data provided by a client device such as client device 110. At step 310, method 300 includes identifying within input data, using an MLM, a set of requests for performing a corresponding set of computer-based tasks. Step 310 includes sub-steps 310A and 310B, which are performed for each request in the set or requests. In sub-step 310A, method 300 includes identifying a task-specific computer application, and in sub-step 310B, method 300 includes determining request-related programming instruction comprising a call to the task-specific computer application using an API associated with the task-specific computer application. In various cases, the machine learning model performs sub-steps 310A and 310B.

After completing step 310, method 300 proceeds to step 320, at which computer instructions are generated outlining a sequence for executing a set of request-related programming instructions. Following step 320, at step 330, method 300 includes processing the computer instructions causing the generating of output data.

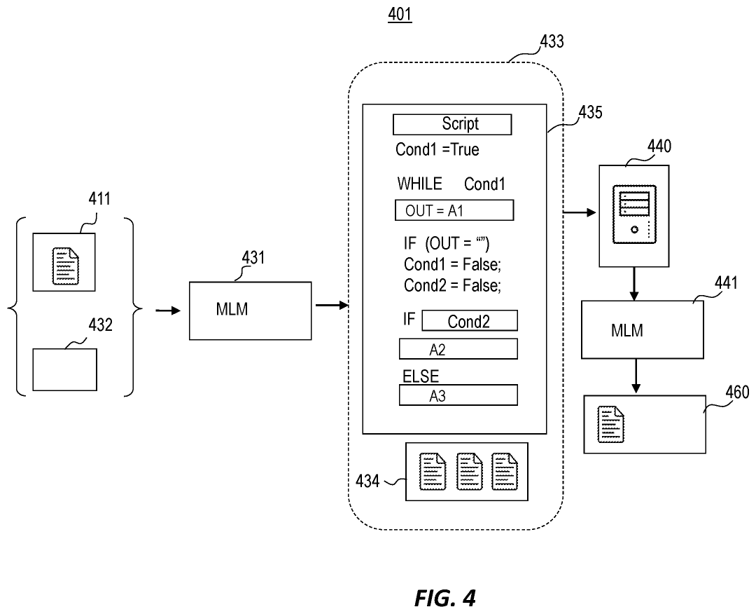

FIG. 4 illustrates methods for generating computer instructions in one embodiment. FIG. 4 shows a diagram 401 illustrating a method of performing a set of API calls, such as A1-A3, to execute computer tasks. Calling APIs can be implemented by first generating computer instructions that include text data 434 and programming instructions 435 describing a process of performing the set of API calls using suitable computer applications. In some cases, programming instructions 435 can be interspersed with text data 434.

As shown in FIG. 4, input data 411, which may include natural language instructions, is provided for an MLM 431. Further, MLM 431 may receive a list of task-specific applications 432, which may be available for performing computer-based tasks. The list of task-specific applications 432 may be similar to or the same as application list 132, as shown in FIG. 1. In various cases, identifying within input data 411 the set of requests includes analyzing input data 411 using natural language processing MLM 431 to identify a set of task-specific applications from the list of task-specific applications 432 for performing the corresponding set of computer-based tasks.

Input data 411 may be similar in structure to input data 111, and MLM 431 may be similar or identical to MLM 131, as shown in FIG. 1. Input data 411 uses natural language to formulate instructions that can be used by MLM 431 to generate computer instructions 433 containing programming instructions 435. Programming instructions 435 may include various logical statements (e.g., conditional IF statements, WHILE, and the like) to determine the logical sequence of execution of various API calls such as A1-A3 calls. As an illustration, in FIG. 4A, programming instructions 435 show APIs A1, A2, and A3 that can be executed by programming instructions 435. In various cases, conditions such as Cond1 and Cond2 may be based on the output parameters of any of the APIs used for programming instructions 435. For example, when performing a while loop, Cond1 may be initially set to “True” and continue being true until the output of a call to API A1 returns a null string.

In an example implementation, computer instructions 133 may include logic for programming instructions 135 determining whether a request-related programming instruction implemented as an API call is performed based on the output of one or more request-related programming instructions. For example, as shown in FIG. 4, if the output of a call to API A1 returns a null string, condition Cond2 evaluates to False, and the API A2 call is not performed.

In various cases, programming instructions 435 together with text data 434 can be used as input for a computing system 440, which is configured to execute programming instructions 435 by performing API calls for A1-A3 APIs. In various cases, computing system 440 may be similar to or the same as second computing system 140, as shown in FIG. 1. After completing the execution of programming instructions 435, computing system 440 may be configured to combine output of API calls A1-A3 with text data 434, process the combined output using an NLP MLM 441 and generate output data 460. Output data 460 may be similar or identical to output data 160, as shown in FIG. 1.

In some cases, when, for a particular request, it is determined, based on the list of task-specific applications 432, that the task-specific computer application for fulfilling the request is not part of the list of the task-specific computer applications 432, MLM 431 may be configured to generate a message indicating that the request cannot be performed. In some cases, the generated message may be part of output data 460.

### 2.3 MLM Training

In various embodiments, machine learning models discussed herein are trained using various input data based on expected output data. For instance, a typical training for a machine learning models such as MLM 131 may include obtaining input data, such as input data 111, generating predicted computer instructions, comparing the predicted computer instructions with expected computer instructions, and adjusting parameters of MLM 131 when the predicted computer instructions do not match the expected computer instructions. The adjustment may include a backpropagation approach for changing parameters (e.g., weights) of one or more neural networks comprising MLM 131.

In an example embodiment, MLM 131 is trained using a training method that includes generating computer instructions by the machine learning model based on training input data, calculating a loss function related to a difference between the generated computer instructions and corresponding expected computer instructions, and updating parameters of the machine learning model to reduce the loss function. The loss function may be any suitable loss function that can be used, for example, for a typical transformer model. For instance, the loss function may be a cross-entropy loss measuring the dissimilarity between the predicted probability distribution and the true probability distribution of words or tokens forming respectively generated and expected computer instructions.

Similarly, an NLP MLM, such as NLP MLM 141, can be trained by obtaining computer instructions, such as computer instructions 133 containing programming instructions 135, executing programming instructions 135 by performing API calls, obtaining results of the API calls (e.g., output results 137) generating predicted output data, comparing the predicted output data with expected output data, and adjusting parameters of MLM 141 when the predicted output data does not match the expected output data.

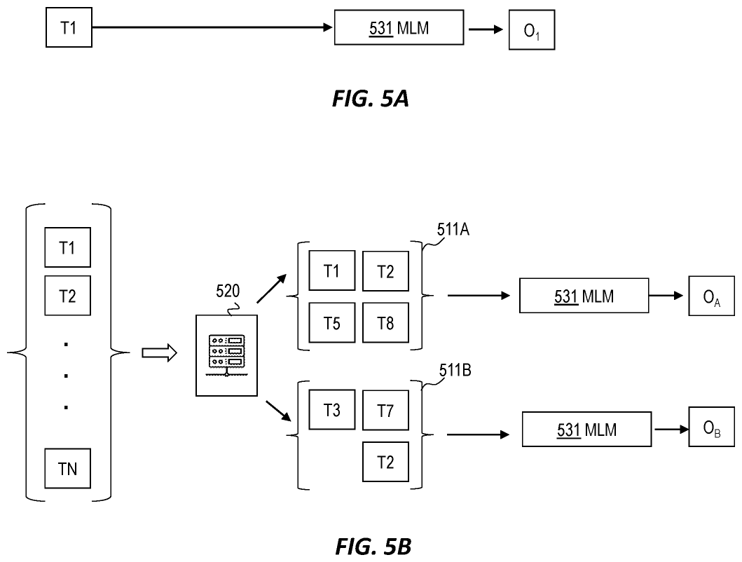

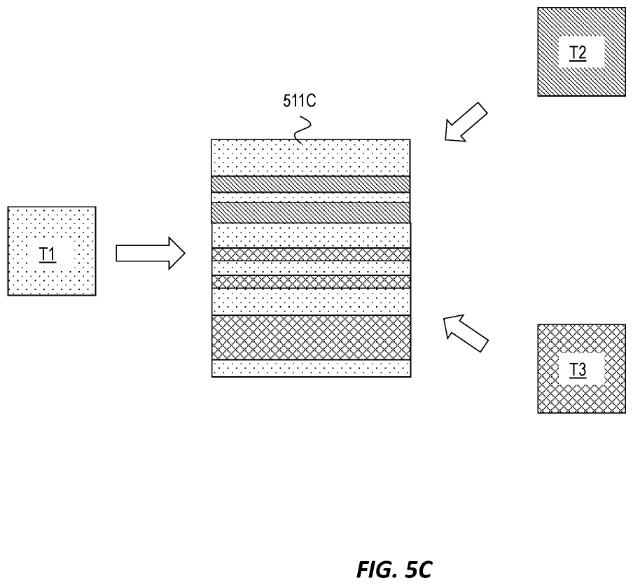

FIG. 5A, FIG. 5B, FIG. 5C are diagrams illustrating a method for generating training data for training a machine-learning system for generating computer instructions in one embodiment. FIG. 5A and FIG. 5B shows a typical process of training an MLM 531, which may be similar or identical to MLM 131, as shown in FIG. 1. In various embodiments when training MLM 531, training input data records T1-TN may be used. For example, FIG. 5A shows a single input training record T1 used to obtain an output O1, which is computer instructions, such as computer instructions 133. Each training input record T1-TN may include one or more requests that need to be identified and for which computer instructions need to be generated. In various cases, MLM 531 may first be trained to accurately predict computer instructions for each one of T1-TN training input data records. Further, after successfully trained on each T1-TN training input data records, MLM 531 may be trained on a combination of several T1-TN records.

For example, FIG. 5B shows that for a set of training input data records T1-TN, a training data generator 520 may be used to combine some of the training input data records to form training input data 511A and 511B. For instance, training input data 511A includes training input data records T1, T2, T5, and T8, and training input data 511B includes training input data records T3, T7, and T2. The generated training input data 511A and 511B can then be used for training MLM 531 to obtain output OA and OB, which can be compared with expected outputs to determine whether any of the parameters of MLM 531 need to be further adjusted.

In some cases, training input data records T1-TN include one or more adjustable parameters. In such case, training data generator 520 is configured to generate the training input data by also adjusting at least one of the one or more adjustable parameters of training input data records T1-TN before combining several training input data records from the plurality of training input data records T1-TN to generate the training input data. In an example embodiment, each one of the one or more adjustable parameters may include a list of possible values, any one of which can be selected for adjusting each one of the adjustable parameters.

In certain scenarios, training data generator 520 could be deliberately programmed to be adversarial towards MLM 531, the machine learning model being trained. This adversarial behavior is characterized by the generator's intentional selection of training input data combinations designed to challenge or subvert the learning process of MLM 531.

For example, the behavior of training data generator 520 might be conditioned on the current state of MLM 531's training progress, particularly focusing on evaluating its loss function. If MLM 531's loss function indicates a high level of accuracy or confidence in its predictions, training data generator 520 might strategically choose input data records that are more complex or ambiguous, thereby challenging the model's capabilities and inducing errors or misclassifications.

Conversely, if MLM 531's loss function suggests that it performs well on certain data types, training data generator 520 might intentionally select combinations of input data records that exploit potential weaknesses or blind spots in the model's understanding. This approach exposes MLM 531 to diverse and challenging scenarios, forcing it to adapt and generalize more effectively.

Using adversarial action in this manner, training data generator 520 plays a crucial role in enhancing the robustness and generalization capabilities of MLM 531. It exposes the model to a broader spectrum of real-world challenges and encourages it to learn more resilient and adaptable representations of the underlying data distribution. As a result, MLM 531 becomes better equipped to handle novel or adversarial inputs encountered during deployment, leading to more reliable and accurate performance in practical applications.

In some cases, training data generator 520 can also be an MLM capable of training to produce and generate training input data. It can be trained to produce challenging training input data while maintaining the relevance of the generated examples to the target training input data. In some cases, training data generator 520 can be based on a foundation transformer model, which can be fine-tuned for generating training input data.

FIG. 5C shows that besides combining individual training input data records T1-TN, elements of various training data records, which may not individually be used for training MLM 531, may be combined into training input data for training MLM 531. For example, elements from training input data records T1, T2, and T3 are combined for training input data 511C.

In various embodiments, the training of machine learning models associated with a system, such as system 100, may be ongoing as various users use system 100. For instance, input data, such as input data 111 from various users together with output data, may be stored in a repository and may be used for further training by, for example, combining different input data to form more complex input data requests.

Furthermore, in some cases, the output data, such as output data 160, may be used, with or without some modifications, as input data 111, thus resulting in one or more iterations before a final output data is generated.

### 3. Implementation Example-Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

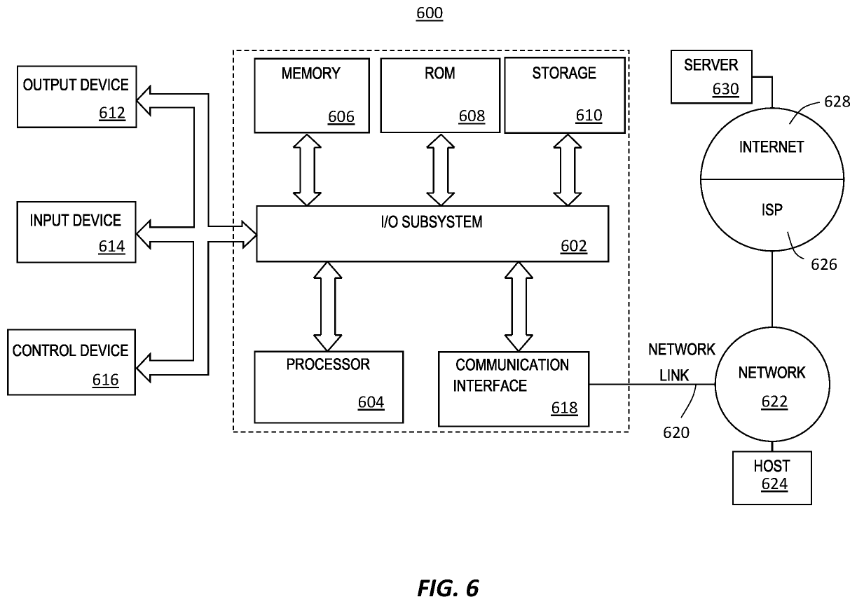

FIG. 6 is a block diagram that illustrates an example computer system with which an embodiment may be implemented. In the example of FIG. 6, a computer system 600 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 600 includes an input/output (I/O) subsystem 602, which may include a bus and/or other communication mechanism(s) for communicating information and/or instructions between the components of the computer system 600 over electronic signal paths. I/O subsystem 602 may include an I/O controller, a memory controller, and at least one I/O port. The electronic signal paths are represented schematically in the drawings, for example, as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 may also be used for storing temporary variables or other intermediate information during the execution of instructions to be executed by processor 604. Such instructions, when stored in non-transitory computer-readable storage media accessible to processor 604, can render computer system 600 into a special-purpose machine customized to perform the operations specified in the instructions.

Computer system 600 includes non-volatile memory such as read-only memory (ROM) 608 or another static storage device coupled to I/O subsystem 602 for storing information and instructions for processor 604. ROM 608 may include various forms of programmable ROM (PROM), such as erasable PROM (EPROM) or electrically erasable PROM (EEPROM). A unit of persistent storage 610 may include various forms of non-volatile RAM (NVRAM), such as FLASH memory, solid-state storage, magnetic disk, or optical disk such as CD-ROM or DVD-ROM and may be coupled to I/O subsystem 602 for storing information and instructions. Storage 610 is an example of a non-transitory computer-readable medium that may be used to store instructions and data, which, when executed by the processor 604, cause performing computer-implemented methods to execute the techniques herein.

The instructions in memory 606, ROM 608, or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer, and data storage layer, such as a relational database system using structured query language (SQL) or no SQL, an object store, a graph database, a flat file system, or other data storage.

Computer system 600 may be coupled via I/O subsystem 602 to at least one output device 612. In one embodiment, output device 612 is a digital computer display. Examples of a display that may be used in various embodiments include a touchscreen display, a light-emitting diode (LED) display, a liquid crystal display (LCD), or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators, or servos.

At least one input device 614 is coupled to I/O subsystem 602 for communicating signals, data, command selections, or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. The control device 616 may be a touchpad, a mouse, a trackball, or cursor direction keys for communicating direction information and command selections to processor 604 and for controlling cursor movement on the output device 612. Control device 616 may have at least two degrees of freedom in two axes, a first axis (e.g., x) and a second axis (e.g., y), that allows the device to specify positions in a plane. Another type of input device may be a wired, wireless, or optical control device such as a joystick, wand, console, steering wheel, pedal, gearshift mechanism or other type of control device. Input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders, and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware, and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire, and fiber optics, including the wires that comprise a bus of I/O subsystem 602. Transmission media can also take the form of acoustic or light waves, such as those generated during radio-wave and infrared data communications.

Various forms of media may carry at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal, and appropriate circuitry can provide the data to I/O subsystem 602, such as placing the data on a bus. I/O subsystem 602 carries the data to memory 606, from which processor 604 retrieves and executes the instructions. The instructions received by memory 606 may optionally be stored on storage 610 before or after execution by processor 604.

Computer system 600 also includes a communication interface 618 coupled to I/O subsystem 602. Communication interface 618 provides a two-way data communication coupling to network link(s) 620 that are directly or indirectly connected to at least one communication network, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork, or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic, or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may connect through network 622 to host 624.

Furthermore, network link 620 may provide a connection through network 622 or to other computing devices via internetworking devices and/or computers that are operated by an Internet Service Provider (ISP) 626. ISP 626 provides data communication services through a worldwide packet data communication network represented as Internet 628. A server 630 may be coupled to Internet 628. Server 630 broadly represents any computer, data center, virtual machine, or virtual computing instance with or without a hypervisor or computer executing a containerized program system such as DOCKER or KUBERNETES. Server 630 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, a server farm, or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer, and data storage layer such as a relational database system using structured query language (SQL) or no SQL, an object store, a graph database, a flat file system, or other data storage.

Computer system 600 can send messages and receive data and instructions, including program code, through the network(s), network link 620, and communication interface 618. In the Internet example, a server 630 might transmit a requested code for an application program through Internet 628, ISP 626, network 622, and communication interface 618. The received code may be executed by processor 604 as it is received and/or stored in storage 610 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the present disclosure have been described with reference to numerous specific details that may vary from implementation to implementation. The specification and drawings are, accordingly, to be regarded in an illustrative rather than a restrictive sense. The sole and exclusive indicator of the scope of the present disclosure, and what is intended by the applicants to be the scope of the present disclosure, is the literal and equivalent scope of the set of claims that issue from this application, in the specific form in which such claims issue, including any subsequent correction.

What is claimed is:

1. A computer-implemented method comprising:
using a machine learning model having a natural language processing capability, identifying, within input data, a task-specific computer application for performing a request for performing a computer-based task, and determining a request-related programming instruction, the request-related programming instruction comprising a call to the task-specific computer application using an application programming interface (API) associated with the task-specific computer application;
repeating the identifying with the input data to yield a set of requests for performing a corresponding set of computer-based tasks;
for the set of requests, generating computer instructions outlining a sequence for executing a set of request-related programming instructions, each one corresponding to the determined request-related programming instruction and having the associated API configured to accept as an input either one or more input parameters generated from identified information within the input data to be used for that API, one or more output parameters from an execution of any of the set of request-related programming instructions, or combination thereof;
processing the computer instructions, causing generating of output data.

2. The computer-implemented method of claim 1, wherein the processing of the computer instruction further causes executing the set of request-related programming instructions, thereby performing the set of computer-based tasks.

3. The computer-implemented method of claim 1, further comprising:
providing, to the machine learning model, a list of task-specific applications available for performing computer-based tasks;
analyzing the input data using natural language processing of the machine learning model to identify a set of task-specific applications from the list of task-specific applications for performing the corresponding set of computer-based tasks.

4. The computer-implemented method of claim 3, further comprising, for a request in the set of requests:
identifying that the task-specific computer application is not part of the list of the task-specific computer applications;
generating a message being a part of the output data indicating that the request cannot be performed.

5. The computer-implemented method of claim 1, wherein the computer-based tasks include one of: scheduling a meeting in a calendar based on one or more time slots identified within the input data, searching for information within a local database based on a search query identified with the input data, searching for information within external information sources based on the search query identified within the input data, uploading data to a local database, based on a set of instructions identified within the input data, processing one or more data records in accordance with the set of instructions, storing processed data records in a storage specified within the input data, moving one or more data records from one database to another database based on the set of instructions, or a combination thereof.

6. The computer-implemented method of claim 5, wherein the search query includes specific terms associated with data stored in the local database, and wherein determining whether to search the local database or the external information sources is determined based on a presence of the specific terms.

7. The computer-implemented method of claim 1, wherein the computer instructions include code-mixed text data; further comprising analyzing the computer instructions using a natural language processing model.

8. The computer-implemented method of claim 1:
wherein the set of request-related programming instructions includes at least a first request-related programming instruction and a second request-related programming instruction, the first request-related programming instruction being configured to generate at least one or more output parameters, and the second request-related programming instruction configured to take as input at least one or more input parameters;
wherein processing the computer instructions comprises executing the first request-related programming instruction, before executing the second request-related programming instruction, thereby generating the one or more output parameters, and using at least one of the one or more output parameters as one of the one or more input parameters of the second request-related programming instruction.

9. The computer-implemented method of claim 8, wherein executing the second request-related programming instruction is not performed based on a value of the at least one of the one or more output parameters of the first request-related programming instruction.

10. The computer-implemented method of claim 1, wherein the computer instructions include one of a Python code, a Ruby code, a Perl Script, a JavaScript code, a Java code, a PHP code, a C code, or a C++ code.

11. The computer-implemented method of claim 1, further comprising generating the computer instructions at least in part by determining based on output of one or more request-related programming instruction from the set of request-related programming instructions whether another request-related programming instruction form the set of request-related programming instructions should be performed.

12. The computer-implemented method of claim 1, further comprising generating the output data by:
executing processing instructions of computer instructions, thereby generating intermediate output data;
processing the intermediate output data using a natural language processing model to generate the output data.

13. The computer-implemented method of claim 1, further comprising training the machine learning model by:
generating computer instructions by the machine learning model based on a training input data;
calculating a loss function related to a difference between the generated computer instructions and corresponding expected computer instructions; and
updating parameters of the machine learning model to reduce the loss function.

14. The computer-implemented method of claim 13, wherein the training input data is generated using a generating model, the generating model is configured to take a plurality of training input data records for which the machine learning model is trained to generate the computer instructions having a required accuracy and combining several training input data records from the plurality of training input data records to generate the training input data.

15. The computer-implemented method of claim 14, wherein the plurality of training input data records include one or more adjustable parameters, and wherein generating the training input data further comprises adjusting at least one of the one or more adjustable parameters prior to combining several input data records from the plurality of training input data records to generate the training input data.

16. The computer-implemented method of claim 15, wherein each one of the one or more adjustable parameters includes a list of possible values, any one of which can be selected for adjusting each one of the adjustable parameters.

17. The computer-implemented method of claim 1 wherein the input data is provided by a client device associated with a user, and wherein the input data is appended to include environmental variables associated with the client device, the environmental variables including access authentication for the client device and specific list of task-specific computer application available for the client device.

18. One or more computer-readable non-transitory storage media storing computer readable programming instructions configured to be executed by one or more processors to perform a method comprising:
using a machine learning model having a natural language processing capability, identifying, within input data, a task-specific computer application for performing a request for performing a computer-based task, and determining a request-related programming instruction, the request-related programming instruction comprising a call to the task-specific computer application using an application programming interface (API) associated with the task-specific computer application;
repeating the identifying with the input data to yield a set of requests for performing a corresponding set of computer-based tasks;
for the set of requests, generating computer instructions outlining a sequence for executing a set of request-related programming instructions, each one corresponding to the determined request-related programming instruction and having the associated API configured to accept as an input either one or more input parameters generated from identified information within the input data to be used for that API, one or more output parameters from an execution of any of the set of request-related programming instructions, or combination thereof;
processing the computer instructions, causing generating of output data.

19. The one or more computer-readable non-transitory storage media of claim 18, wherein the processing of the computer instruction further causes executing the set of request-related programming instructions, thereby performing the set of computer-based tasks.

20. The one or more computer-readable non-transitory storage media of claim 18, wherein the method further comprises:
providing, to the machine learning model, a list of task-specific applications available for performing computer-based tasks;
analyzing the input data using natural language processing of the machine learning model to identify a set of task-specific applications from the list of task-specific applications for performing the corresponding set of computer-based tasks.
